(19) United States
(12) Patent Application Publication
(10) Pub. No.: US 2014/0358589 A1
(43) Pub. Date: Dec. 4, 2014

(54) SYSTEM, METHOD, APPARATUS, AND COMPUTER PROGRAM PRODUCT FOR PROVIDING LOSS DRAFT INSURANCE

(71) Applicant: Assurant, Inc., New York, NY (US)

(72) Inventors: Mark Robert Schmitt, San Clemente, CA (US); Gregory Marshall Tuttle, Acworth, GA (US); Dennis Dominick Bruno, Florence, SC (US); Paul Douglas Gamm, Roswell, GA (US); Bhupinder Paul Singh, Lake Forest, IL (US)

(21) Appl. No.: 13/905,944

(22) Filed: May 30, 2013

(51) Int. Cl. G06Q 40/08

(52) U.S. Cl. CPC G06Q 40/08
USPC 705/4

(57) ABSTRACT

Systems, methods, apparatuses and computer program products are provided for providing loss draft insurance. In this regard, certain example embodiments may provide a loss draft insurance product having terms which provide for a reimbursement payment to be made to a lender in the event that the lender is required to repurchase a secured loan due to a release of loss draft funds, or in the event that the borrower becomes delinquent on the secured loan. Certain other example embodiments may provide risk analysis capabilities for determining eligibility for the aforementioned loss draft insurance product.

### TECHNOLOGICAL FIELD

Embodiments of the present invention relate generally to computer-implemented insurance technology and, more particularly, relate to a system, method, apparatus, and computer program product for providing loss draft insurance.

### BACKGROUND

A loss draft is a payment of insurance proceeds for a claim resulting from a loss to collateral used to secure a loan. The owner or servicer of the secured loan (i.e., the lender) is included as a payee on a loss draft. Thus, for example, if a home securing a mortgage is damaged, the mortgagor (borrower) may file an insurance claim for the damage and the insurance company may issue a loss draft with both the borrower and lender indicated as payees.

### BRIEF SUMMARY OF EXAMPLE EMBODIMENTS

Systems, methods, apparatuses and computer program products are therefore provided herein for providing loss draft insurance. In this regard, certain example embodiments may provide a loss draft insurance product having terms which provide for a reimbursement payment to be made to a lender in the event that the lender is required to repurchase a secured loan due to a release of loss draft funds, or in the event that the borrower becomes delinquent on the secured loan. Certain other example embodiments may provide modeling capabilities to evaluate one or more risk components associated with a given release of loss draft funds, so as to, for example, determine eligibility for the aforementioned insurance product.

For example, in one embodiment a method is provided that includes receiving information regarding a loan secured by collateral, receiving information regarding an insurance claim for a loss to the collateral, receiving information regarding one or more macroeconomic factors related to the loan secured by collateral, determining, via a processor, a delinquency score based at least in part on the received information and determining, based at least in part on the delinquency score, whether to support an un-monitored release of loss draft funds. Determining whether to support an un-monitored release of the loss draft funds may include comparing the delinquency score to a predetermined threshold. In an instance in which it is determined to support the un-monitored release of loss draft funds, the method may include receiving an indication that at least a portion of the released loss draft funds have not been applied to repairing the loss to the collateral, and providing an authorization to release a reimbursement payment in an instance in which, within a delinquency period, the secured loan has been repurchased or the secured loan enters delinquency. In some embodiments receiving information regarding an insurance claim for a loss to the collateral includes receiving information regarding a plurality of insurance claims and the method further includes filtering from the information regarding the plurality of insurance claims, information regarding insurance claims known to be associated with delinquent loans.

In some embodiments, the information regarding the loan secured by collateral includes one or more of a state, an original mortgage amount, an original property value, a principal balance, a coverage amount, a current property value, an interest rate, and an origination date. The information regarding the loan secured by collateral may also include an investor name.

In some embodiments, the information regarding one or more macroeconomic factors includes loan delinquency information. In yet further embodiments, the information regarding one or more macroeconomic factors includes information regarding an unemployment rate. In some embodiments, the information regarding one or more macroeconomic factors includes one or more interest rates of one or more US Treasury Bonds. The interest rates of the one or more US Treasury Bonds may include the interest rate of a 10 year US Treasury Bond. The interest rate of the one or more US Treasury Bonds may include the interest rate of one or more US Treasury Bonds calculated on or after an origination date of the loan secured by collateral.

In some embodiments, the loss draft funds may be released by a loss draft vendor selected from a plurality of approved loss draft vendors. In another embodiment, the delinquency period is two years. In some embodiments, the reimbursement payment includes a first amount equal to the released funds minus a value of repairs performed on the collateral. The reimbursement payment may further include a second amount equal to any administrative expenses directly resulting from the insured party's required repurchase of the secured loan, the administrative expenses not including the actual repurchase amount. The second amount may be capped at a percentage of the first amount. The percentage of the first amount may be 25%. The reimbursement payment may be capped based at least in part on the delinquency score. In additional embodiments, the method may also include determining a premium payment based at least in part on the delinquency score.

In a further embodiment, an apparatus is provided that includes at least one processor and at least one memory storing program code instructions therein, the memory and program code instructions being configured to, with the processor, cause the apparatus to at least receive information regarding a loan secured by collateral, receive information regarding one or more macroeconomic factors related to the loan secured by collateral, determine a delinquency score based at least in part on the received information, and determine, based at least in part on the delinquency score, whether to support an un-monitored release of loss draft funds. The determining whether to support the unmonitored release of loss draft funds may include comparing the delinquency score to a threshold. In an instance in which it is determined to support the un-monitored release of loss draft funds, the apparatus may also be caused to receive an indication that at least a portion of the released loss draft funds have not been applied to repairing the loss to the collateral, and to provide an authorization to release a reimbursement payment in an instance in which, within a delinquency period, the secured loan has been repurchased or the secured loan enters delinquency. The apparatus may be caused to receive a plurality of insurance claims and, the apparatus may be further caused to filter information regarding insurance claims known to be associated with delinquent loans from the information regarding the plurality of insurance claims. The information regarding the loan secured by collateral may include one or more of: a state, an original mortgage amount, an original property value, a principal balance, a coverage amount, a current property value, an interest rate, and an origination date. In some embodiments, the information regarding the loan secured by collateral further includes an investor name.

In some embodiments, the information regarding one or more macroeconomic factors may include loan delinquency information. The information regarding one or more macroeconomic factors may also include information regarding an unemployment rate. In some embodiments, the information regarding one or more macroeconomic factors includes one or more interest rates of one or more US Treasury Bonds. The interest rates of the one or more US Treasury Bonds may include the interest rate of a 10 year US Treasury Bond. In some embodiments, the interest rate of the one or more US Treasury Bonds includes the interest rate of one or more US Treasury Bonds calculated on or after an origination date of the loan secured by collateral.

In some embodiments, the loss draft funds are released by a loss draft vendor selected from a plurality of approved loss draft vendors. In some embodiments, the delinquency period may be two years. The reimbursement payment may include a first amount equal to the released funds minus a value of repairs performed on the collateral. The reimbursement payment may further include a second amount equal to any administrative expenses directly resulting from the insured party's required repurchase of the secured loan, and the administrative expenses may not include the actual repurchase amount. In some embodiments, the second amount is capped at a percentage of the first amount. The percentage of the first amount may be 25%. In yet further embodiments, the reimbursement payment is capped based at least in part on the delinquency score. The apparatus may be further caused to determine a premium payment based at least in part on the delinquency score.

In a further embodiment, a computer program product is provided that includes a non-transitory computer readable medium storing computer program code portions therein, the computer program code portions being configured to, upon execution, cause an apparatus to at least receive information regarding loan secured by collateral, receive information regarding one or more macroeconomic factors related to the loan secured by collateral, determine a delinquency score based at least in part on the received information, and determine, based at least in part on the delinquency score, whether to support an un-monitored release of loss draft funds by at least comparing the delinquency score to a threshold. In an instance in which it is determined to support the un-monitored release of loss draft funds, the computer program code portions may be configured to, upon execution, cause the apparatus to at least receive an indication that at least a portion of the released loss draft funds have not been applied to repairing the loss to the collateral, and provide an authorization to release a reimbursement payment in an instance in which, within a delinquency period, the secured loan has been repurchased or the secured loan enters delinquency. The apparatus may be caused to receive a plurality of insurance claims, the apparatus being further caused to filter from the information regarding the plurality of insurance claims, information regarding insurance claims known to be associated with delinquent loans.

In some embodiments, the information regarding the loan secured by collateral may include one or more of: a state, an original mortgage amount, an original property value, a principal balance, a coverage amount, a current property value, an interest rate, and an origination date. The information regarding the loan secured by collateral may also include an investor name. The information regarding one or more macroeconomic factors may also include loan delinquency information. In yet further embodiments, the information regarding one or more macroeconomic factors includes information regarding an unemployment rate. In some embodiments, the information regarding one or more macroeconomic factors comprises one or more interest rates of one or more US Treasury Bonds. The interest rates of the one or more US Treasury Bonds may include the interest rate of a 10 year US Treasury Bond. The interest rate of the one or more US Treasury Bonds may also include the interest rate of one or more US Treasury Bonds calculated on or after an origination date of the loan secured by collateral.

In some embodiments, the loss draft funds are released by a loss draft vendor selected from a plurality of approved loss draft vendors. The delinquency period may be two years. In another embodiment, the reimbursement payment may include a first amount equal to the released funds minus a value of repairs performed on the collateral. In yet another embodiment, the reimbursement payment further includes a second amount equal to any administrative expenses directly resulting from the insured party's required repurchase of the secured loan. The administrative expenses may not include the actual repurchase amount. The second amount may be capped at a percentage of the first amount. In some embodiments, the percentage of the first amount is 25%. The reimbursement payment may be capped based at least in part on the delinquency score. The apparatus may be further caused to determine a premium payment based at least in part on the delinquency score.

### BRIEF DESCRIPTION OF THE SEVERAL VIEWS OF THE DRAWINGS

Having thus described embodiments of the invention in general terms, reference will now be made to the accompanying drawings, which are not necessarily drawn to scale, and wherein:

FIG. 1 is a flow chart of a system which may benefit from various embodiments of the present invention;

FIG. 2 is a block diagram of a system for providing loss draft insurance according to an example embodiment;

FIG. 3 is a schematic diagram of a plan implementation component according to one example embodiment;

FIG. 4 is a block diagram of a plan implementation system according to a further example embodiment;

FIG. 5 is a schematic diagram of a risk analysis component according to one example embodiment;

FIG. 6 is a flowchart illustrating terms of an insurance policy configured in accordance with an example embodiment; and

FIG. 7 is a flowchart illustrating risk analysis operations performed in accordance with an example embodiment.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, and/or the like. Similarly, where a computing device is described herein to send data to another computing device, it will be appreciated that the data may be sent directly to the another computing device or may be sent indirectly via one or more intermediary computing devices, such as, for example, one or more servers, relays, routers, network access points, base stations, and/or the like.

### System Overview

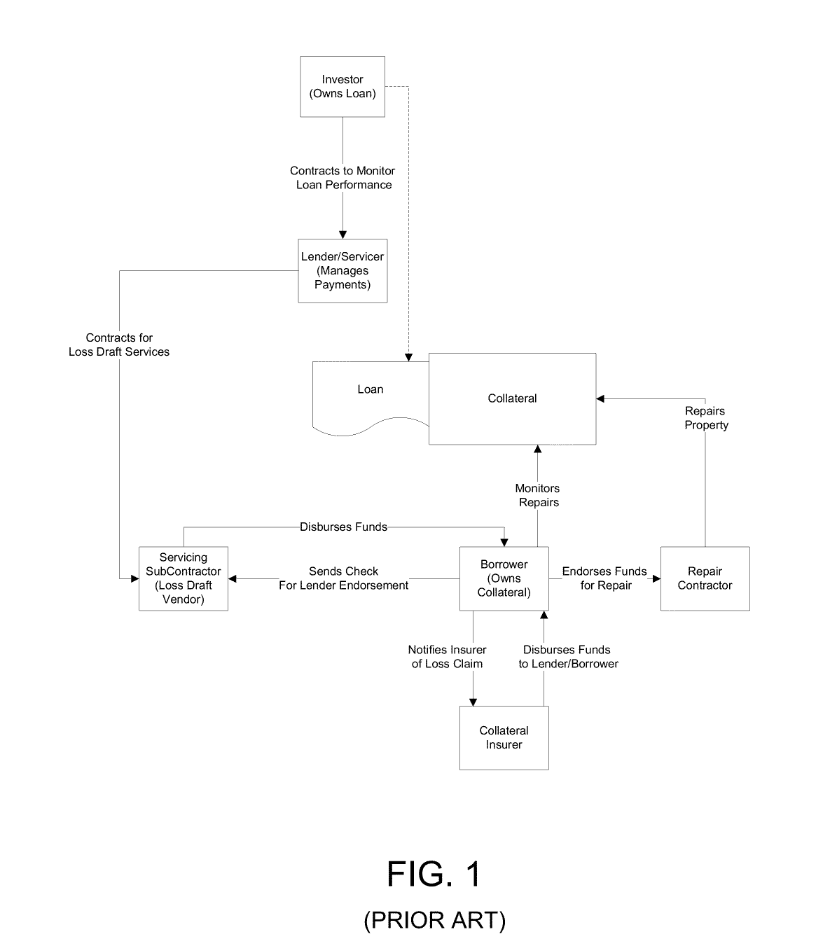

Disclosed are various systems, methods, apparatuses, and computer program products for providing loss draft insurance products. FIG. 1 depicts an example of a system of parties and transactions which may benefit from example embodiments of the present invention. In this regard, and with reference to FIG. 1, a loss draft is a payment of insurance proceeds for a claim resulting from a loss to collateral used to secure a loan. As discussed in the Background section, the owner or servicer of the secured loan (i.e., the lender) is included as a payee on a loss draft. Thus, for example, if a home securing a mortgage is damaged, the mortgagor (borrower) may file an insurance claim for the damage and the insurance company may issue a loss draft with both the borrower and lender indicated as payees. However, since the lender has an interest in ensuring that the collateral is repaired using the disbursed funds, the funds may require endorsement by the lender before the funds are released to the borrower. A loan servicing subcontractor (e.g., a loss draft vendor) may oversee the release of these funds to the borrower. However, the lender may require the loss draft vendor to monitor the disbursement of these funds to the borrower to ensure that the borrower uses the funds to repair the collateral (e.g., by paying a repair contractor to repair the collateral). In order to mitigate the risk of the buyer using the funds for purposes other than repair of the collateral, the loss draft vendor may only release a portion of the funds at a time.

Since monitoring of the released funds may be a time consuming and expensive endeavor, the lender may authorize the release of some of the funds without monitoring by the loss draft vendor. However, the lack of monitoring exposes the lender to the risk that the borrower will not use the funds to repair the collateral. Thus, lenders conventionally limit these types of un-monitored and direct fund releases to claims involving relatively small loss drafts.

Thus, according to some embodiments, loss draft insurance products may provide for a reimbursement payment to be made to the lender in the event that the borrower fails to use the released funds to repair the collateral and, for example, the lender is required to repurchase a secured loan due to a release of loss draft funds, such as from an investor, or, according to another example, the borrower becomes delinquent on the secured loan. Certain other example embodiments may provide modeling capabilities to evaluate one or more risk components associated with a given release of loss draft funds. In this way, eligibility for a loss draft insurance product may be determined.

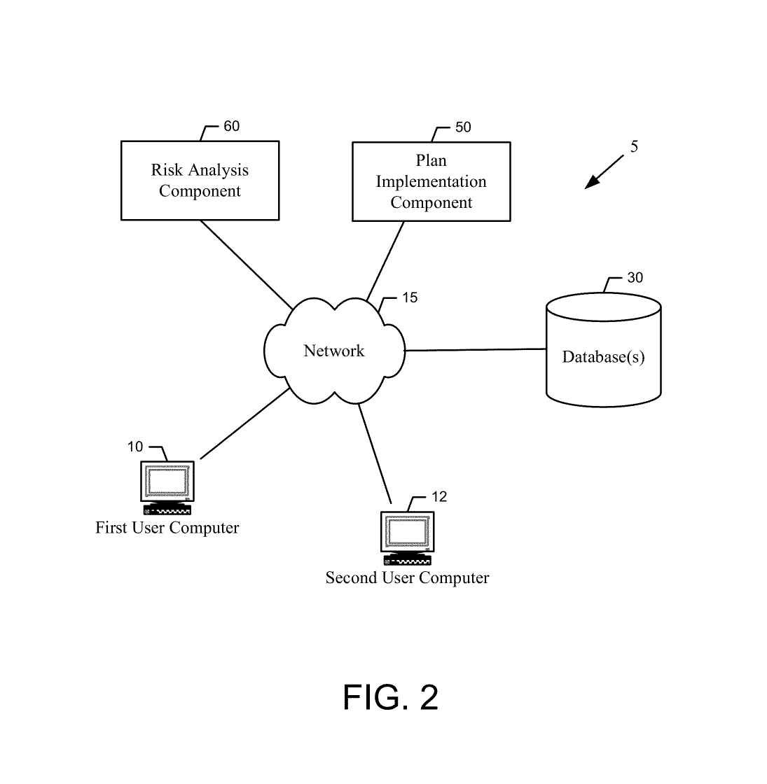

FIG. 2 depicts an example of a system 5 which may be configured according to an example embodiment. As may be understood from this figure, in this embodiment, the system 5 includes one or more user computers 10, 12 that are connected, via a network 15 (e.g., a LAN or the Internet), to communicate with a Plan Implementation component 50 and a Risk Analysis Component 60. The first user computer 10 and the second user computer 12 are merely shown to illustrate the potential for multiplicity in relation to the number of terminals that may interface with the Plan Implementation Component 50 and Risk Analysis Component 60. Thus, some embodiments may employ only one of the first user computer 10 and the second user computer 12, while other embodiments may employ two or more such computers.

In an example embodiment, the system 5 may be configured for retrieving data from and storing data to a database 30 that may be stored on (or, alternatively, stored remotely from) the Plan Implementation Component 50 and/or Risk Analysis Component 60. It will be further understood that although the Plan Implementation Component 50 and Risk Analysis Component 60 are illustrated as being embodied by separate components in FIG. 2, they may, according to other example embodiments, be embodied by a single component or even distributed across more than two components.

In an example embodiment, either or both of the first user computer 10 and the second user computer 12 may be a personal computer (PC) or a laptop computer associated with a particular individual or organization. For example, one or more computers may be associated with consumers and another one or more computers may be associated with an insurance company or financial institution. However, in other cases, either or both of the first user computer 10 and the second user computer 12 may be a personal digital assistant (PDA), mobile telephone (or smart phone), or a client terminal associated with a financial institution, an insurance provider or other entity. As such, in some cases, the first user computer 10 or second user computer 12 may represent a terminal for providing user interface with the system 5.

In some embodiments, middleware associated with a particular financial institution or insurance provider may be provided between the computers and the Plan Implementation Component 50 and/or Risk Analysis Component 60 to enable either or both of the Plan Implementation Component 50 and/or Risk Analysis Component 60 to interface with corresponding different input terminals. Moreover, in some embodiments, the Plan Implementation Component 50 and/or Risk Analysis Component 60 may host a website accessible by the either or both of the first user computer 10 and the second user computer 12 to enable policy setup, policy modification and/or claims reporting.

It should be appreciated that FIG. 2 illustrates one example system 5 that may be configured according to an example embodiment, and that numerous other configurations may be equally applicable to various other example embodiments. Thus, for example, some embodiments may include additional components, fewer components, or different components than those illustrated in FIG. 2. Generally speaking, the system 5 may be configured to enable risk analysis and prequalification, data capture and insurance policy enrollment, insurance policy setup, insurance policy administration, claim processing, and/or the like. Various types of data, such as data associated with the insurance policy or data used in risk analysis, may then be stored in the database 30, and retrieved therefrom as needed to perform functionalities described herein.

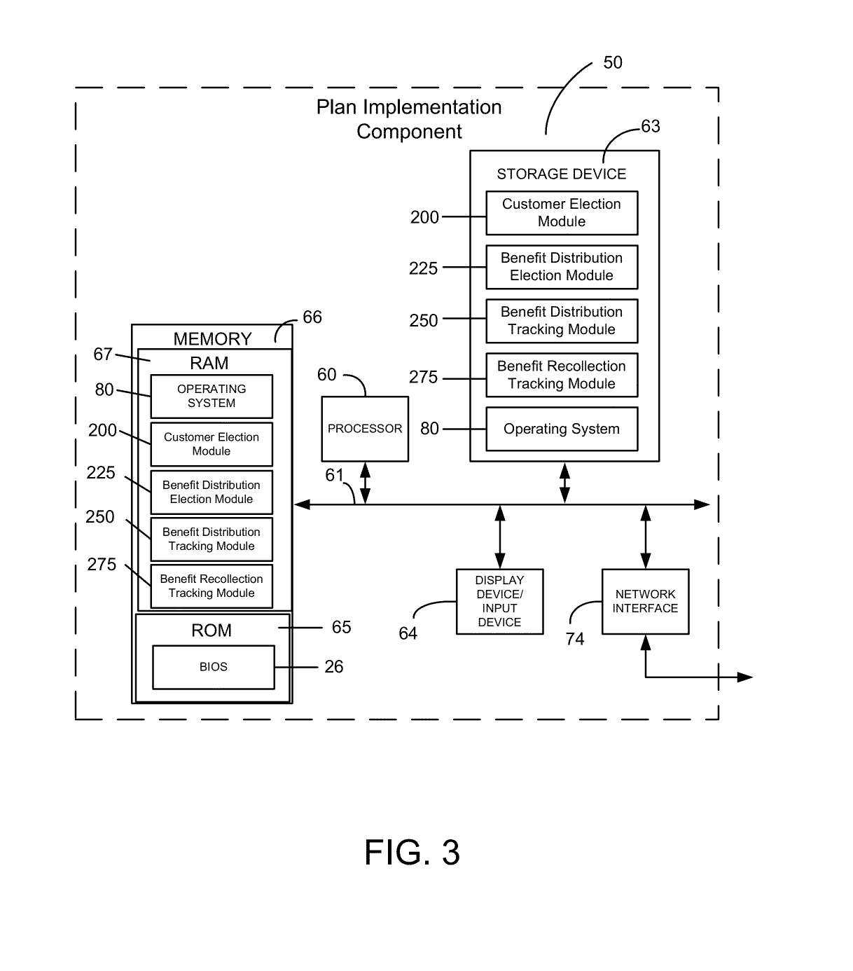

FIG. 3 shows a schematic diagram of the Plan Implementation Component 50 according to one embodiment of the invention. The Plan Implementation Component 50 may include one or more processors 60 that communicate with other elements within the Plan Implementation Component 50 via a system interface or bus 61. A display device/input device 64 for receiving and displaying data may also be included in the Plan Implementation Component 50. This display device/input device 64 may be, for example, a keyboard or pointing device that is used in combination with a monitor. The Plan Implementation Component 50 may further include one or more memory devices 66, which may include read only memory (ROM) 65 and/or random access memory (RAM) 67. The ROM 65 may be used to store a basic input/output system 26 (BIOS), containing the basic routines that help to transfer information between elements within the Plan Implementation Component 50.

The Plan Implementation Component 50 may additionally include at least one storage device 63, such as a hard disk drive, solid state drive, a floppy disk drive, an optical drive, and/or the like, for storing information on various non-transitory computer-readable media, such as solid state memory, a hard disk, a removable magnetic disk, an CD or DVD-ROM disk, and/or the like. As will be appreciated by one of ordinary skill in the art, each of these storage devices 63 may be connected to the system bus 61 by an appropriate interface. The storage devices 63 and their associated computer-readable media provide nonvolatile storage for a personal computer. It is important to note that the computer-readable media described above could be replaced by any other type of non-transitory computer-readable media known in the art.

A number of program modules may be stored by the various storage devices and within RAM 67. Such program modules include an operating system 80, a Customer Election Module 200, a Benefit Distribution Election Module 225, a Benefit Distribution Tracking Module 250, and a Benefit Recollection Tracking Module 275. The Customer Election Module 200, the Benefit Distribution Election Module 225, the Benefit Distribution Tracking Module 250, and the Benefit Recollection Tracking Module 275 may control certain aspects of the operation of the Plan Implementation Component 50, as is described in more detail below, with the assistance of the processor 60 and the operating system 80.

The Plan Implementation Component 50 may further comprise a network interface 74, for interfacing and communicating with other elements of a computer network. It will be appreciated by one of ordinary skill in the art that one or more of the Plan Implementation Component 50 components may be located geographically remotely from other Plan Implementation Component 50 components. Furthermore, one or more of the components may be combined, and additional components performing functions described herein may be included in the Plan Implementation Component 50.

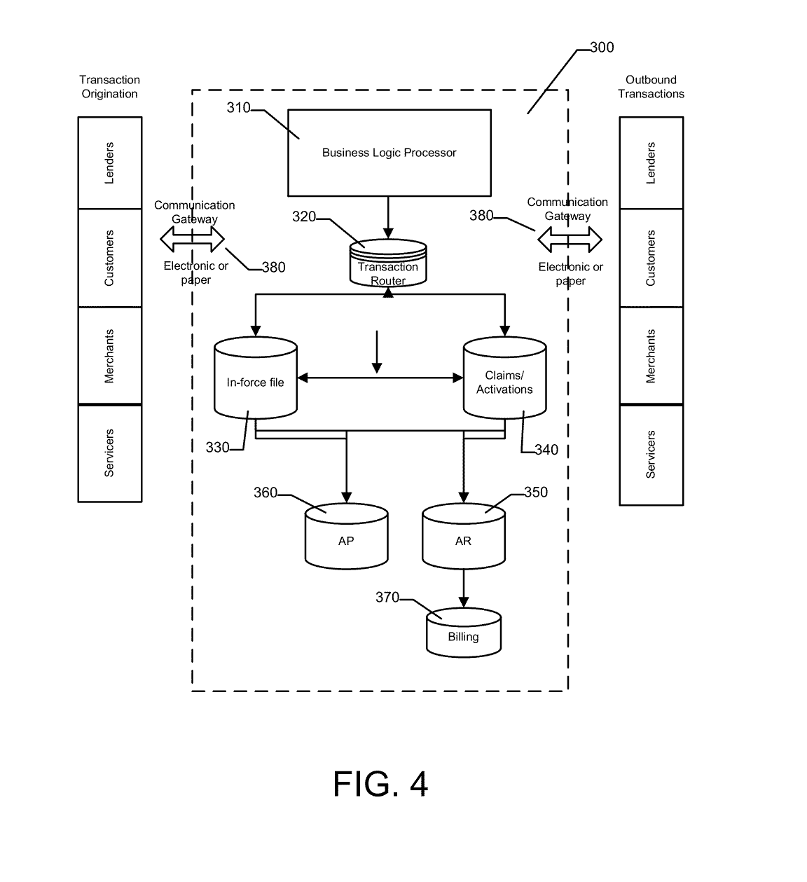

FIG. 4 depicts another embodiment of a plan implementation component. In this embodiment, the Plan Implementation Component 300 may include a Business Logic Processor 310 that is adapted for receiving and processing transaction information, and for passing the information to a Transaction Router 320, which routes information regarding the transaction to various other components of the system 300 for processing. The system 300 may further include an In-Force File 330, which may be, for example, a database or file that stores a listing of plans/policies that are currently in force. The system 300 may further include a Claims/Activations Server 340 that is configured for processing activations of new plans/policies, and for processing claims filed under those policies.

In some example embodiments, the system 300 may also include an Accounts Receivable Server 350 and a Billing Server 370, which are configured, respectively, to handle accounts receivable information and to process bills. In addition, the system 300 includes an Accounts Payable Server 360 for handling accounts payable.

In some example embodiments, the system 300 may also include a communication gateway 380 that may be configured to facilitate communications between the system 300 and, for example, servicers, merchants, customers, and lenders. The communication gateway 380 may, for example, be configured to handle the following types of inbound transactions and information: (1) new enrollments; (2) information regarding new insured parties; (3) borrower loan information; (4) instructions on cash disbursements; (5) billing transactions; and/or (6) receiving indications regarding the satisfaction of various policy conditions. The communication gateway 380 may, for example, be configured to handle the following types of outbound transactions and information: (1) fulfillment package information; (2) requests for benefit communications; (3) payments; (4) billing; and (5) customer service communications.

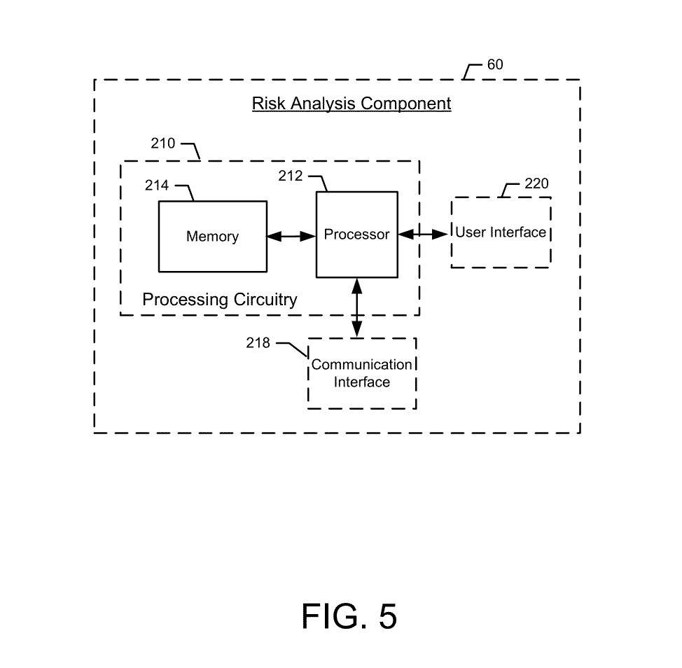

FIG. 5 depicts an example embodiment of a Risk Analysis Component 60. However, it should be noted that the components, devices or elements illustrated in and described with respect to FIG. 5 below may not be mandatory and thus some may be omitted in certain embodiments. Additionally, some embodiments may include further or different components, devices or elements beyond those illustrated in and described with respect to FIG. 5.

Referring now to FIG. 5, the Risk Analysis Component 60 may include or otherwise be in communication with processing circuitry 210 that is configurable to perform actions in accordance with one or more example embodiments disclosed herein. In this regard, the processing circuitry 210 may be configured to perform and/or control performance of one or more functionalities of the Risk Analysis Component 60 in accordance with various example embodiments, and thus may provide means for performing functionalities of the Risk Analysis Component 60 in accordance with various example embodiments. The processing circuitry 210 may be configured to perform data processing, application execution and/or other processing and management services according to one or more example embodiments.

In some embodiments, the Risk Analysis Component 60 or a portion(s) or component(s) thereof, such as the processing circuitry 210, may be embodied as or comprise a chip or chip set. In other words, the Risk Analysis Component 60 or the processing circuitry 210 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The Risk Analysis Component 60 or the processing circuitry 210 may therefore, in some cases, be configured to implement an embodiment of the invention on a single chip or as a single “system on a chip.” As such, in some cases, a chip or chipset may constitute means for performing one or more operations for providing the functionalities described herein.

In some example embodiments, the processing circuitry 210 may include a processor 212 and, in some embodiments, such as that illustrated in FIG. 5, may further include memory 214. The processing circuitry 210 may be in communication with or otherwise control a communication interface 218 and/or a support services controller 220. As such, the processing circuitry 210 may be embodied as a circuit chip (e.g., an integrated circuit chip) configured (e.g., with hardware, software or a combination of hardware and software) to perform operations described herein.

The processor 212 may be embodied in a number of different ways. For example, the processor 212 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 212 may comprise a plurality of processors. The plurality of processors may be in operative communication with each other and may be collectively configured to perform one or more functionalities of the Risk Analysis Component 60 as described herein. The plurality of processors may be embodied on a single computing device or distributed across a plurality of computing devices collectively configured to function as the Risk Analysis Component 60. In some example embodiments, the processor 212 may be configured to execute instructions stored in the memory 214 or otherwise accessible to the processor 212. As such, whether configured by hardware or by a combination of hardware and software, the processor 212 may represent an entity (e.g., physically embodied in circuitry—in the form of processing circuitry 210) capable of performing operations according to embodiments of the present invention while configured accordingly. Thus, for example, when the processor 212 is embodied as an ASIC, FPGA or the like, the processor 212 may be specifically configured hardware for conducting the operations described herein. Alternatively, as another example, when the processor 212 is embodied as an executor of software instructions, the instructions may specifically configure the processor 212 to perform one or more operations described herein.

In some example embodiments, the memory 214 may include one or more non-transitory memory devices such as, for example, volatile and/or non-volatile memory that may be either fixed or removable. In this regard, the memory 214 may comprise a non-transitory computer-readable storage medium. It will be appreciated that while the memory 214 is illustrated as a single memory, the memory 214 may comprise a plurality of memories. The plurality of memories may be embodied on a single computing device or may be distributed across a plurality of computing devices collectively configured to function as the Risk Analysis Component 60. The memory 214 may be configured to store information, data, applications, instructions and/or the like for enabling the Risk Analysis Component 60 to carry out various functions in accordance with one or more example embodiments. For example, the memory 214 may be configured to buffer input data for processing by the processor 212. Additionally or alternatively, the memory 214 may be configured to store instructions for execution by the processor 212. As yet another alternative, the memory 214 may include one or more databases that may store a variety of files, contents or data sets. Among the contents of the memory 214, applications may be stored for execution by the processor 212 in order to carry out the functionality associated with each respective application. In some cases, the memory 214 may be in communication with one or more of the processor 212, communication interface 218, or support services controller 220 via a bus(es) for passing information among components of the Risk Analysis Component 60.

The communication interface 218 may include one or more interface mechanisms for enabling communication with other devices and/or networks. In some cases, the communication interface 218 may be any means such as a device or circuitry embodied in either hardware, or a combination of hardware and software that is configured to receive and/or transmit data from/to a network and/or any other device or module in communication with the processing circuitry 210. By way of example, the communication interface 218 may be configured to enable the Risk Analysis Component 60 to communicate with one or more user computers 10, 12, the Plan Implementation Component 50, the database(s) 30, and/or other computing device(s) via the network 15. Accordingly, the communication interface 218 may, for example, include an antenna (or multiple antennas) and supporting hardware and/or software for enabling communications with a wireless communication network (e.g., a wireless local area network, cellular network, and/or the like) and/or a communication modem or other hardware/software for supporting communication via cable, digital subscriber line (DSL), universal serial bus (USB), Ethernet or other methods.

In some example embodiments, the processor 212 (or the processing circuitry 210) may further be in communication with a user interface 220 configured to receive indications of user input and to cause audible, visual, mechanical or other output to be provided to the user. As such, the user interface 220 may, for example, include a keyboard, a mouse, a joystick, a display, a touch screen(s), touch areas, soft keys, a microphone, a speaker, or other input/output mechanisms. The processor 212 may be configured to control one or more functions of one or more user interface elements through computer program instructions (e.g., software and/or firmware) stored on a memory accessible to the processor 212 (e.g., memory device 214). In other embodiments, however, the Risk Analysis Component 60 may not include a user interface 220. According to even further example embodiments, the Risk Analysis Component 60 may not include a user interface 220, but may instead be in communication with a user interface of another device, such as one or more of the user computers 10, 12, the Plan Implementation Component 50, the database(s) 30, and/or other computing device(s) via the network 15.

### Loss Draft Insurance Product

As discussed in the Background section, a loss draft is a payment of insurance proceeds for a claim resulting from a loss to collateral used to secure a loan. Because the owner or servicer of the secured loan (i.e., the lender) is included as a payee on a loss draft, it is necessary for the lender to have the loss draft funds released to the borrower. Lenders will occasionally have the loss draft funds released directly to the borrower by a loss draft vendor, depending on the size of the claim and the various policies of the lender. Furthermore, the lender may wish to have such funds released by the loss draft vendor to the borrower without the loss draft vendor monitoring the borrower to ensure the loss draft funds are used to repair the collateral. This can be convenient for all of the involved parties and also reduces transaction costs.

However, having the funds directly released without monitoring also creates risk for the lender. For example, the borrower may fail to make the repairs on the collateral property, thus decreasing its value and, in some cases, necessitating a purchase of the property by the lender. In other cases, the borrower may fail to make the repairs and then become delinquent on the loan. Because of these risks, lenders ordinarily limit un-monitored and direct fund releases to claims involving relatively small loss drafts. Thus, if protection against these risks could be provided, this would allow larger un-monitored and direct fund releases, thereby increasing convenience and reducing transaction costs.

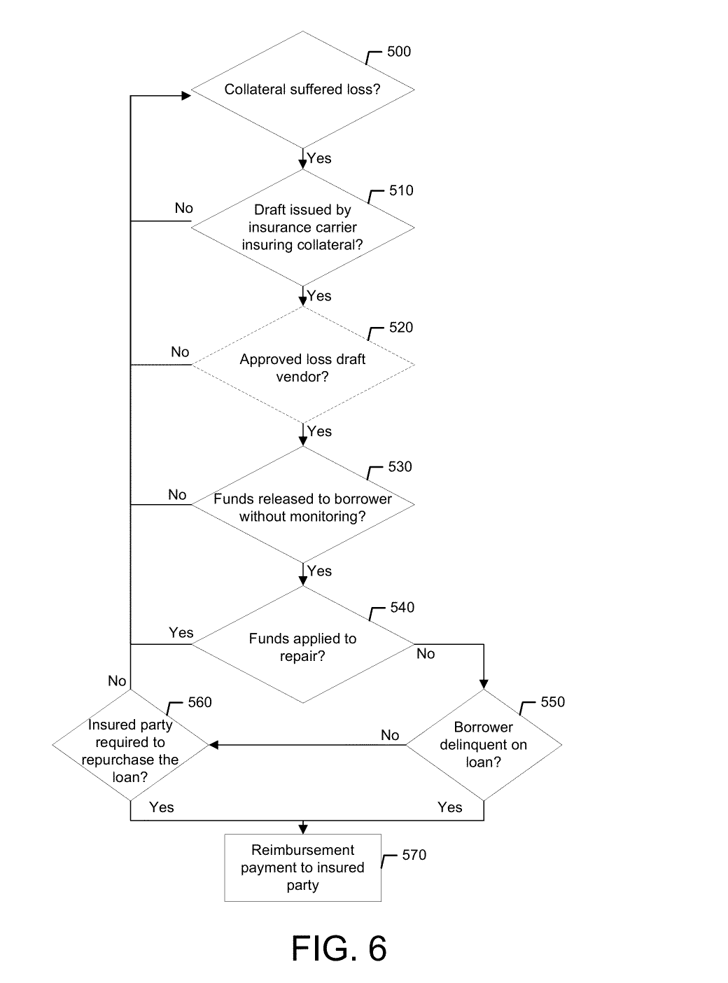

Accordingly, example embodiments may provide a loss draft insurance product which includes terms providing for a reimbursement payment to be made to an insured party, e.g., an owner or servicer of a loan secured by collateral property, in an instance in which various conditions associated with a loss draft are satisfied. Examples of these conditions are depicted by way of a flow chart in FIG. 6. It will be understood that satisfaction of each of the conditions depicted in FIG. 6 and described below may be determined, for example, by the Plan Implementation Component 50. That is, the Plan Implementation Component 50 may comprise means, such as the processor(s) 60, the memory device(s) 66, the network interface 74, and/or the like, for determining whether any/all of the conditions have been satisfied and/or receiving indications of the satisfaction of any/all of the conditions. Moreover, the Plan Implementation Component 50 may further comprise means, such as those just listed, for, in an instance in which the conditions have been satisfied, causing a reimbursement payment to be made to the insured party.

As shown in FIG. 6, the conditions may comprise a requirement that collateral property securing a particular secured loan made to a borrower suffers a loss. See condition 500. The insured party may be either an owner or servicer of the secured loan, e.g., the lender. The collateral property may, according to an example embodiment, comprise real property. The real property may thus, for example, secure a mortgage loan made by the insured party.

The conditions may, according to an example embodiment, further comprise a requirement that in association with the above loss, the insurance carrier insuring the collateral property issues a draft. See condition 510. As discussed above, the draft may be issued to the insured party, e.g., lender, such as either directly to the lender or with the lender being listed as a co-payee with the borrower. Condition 510 may, according to other example embodiments, include a restriction on the amount of the draft, e.g., a minimum and/or maximum amount of the draft. For example, one embodiment may provide that the amount of the draft must be between $10,000 and $30,000. Other example embodiments may provide other ranges or may only provide a minimum or only a maximum draft amount.

The conditions may, according to an example embodiment, further comprise a requirement that the insured party use an approved draft loss vendor. See condition 520. Condition 520 may thus include a list of approved draft loss vendors or, according to another example embodiment, one or more characteristics of an approved draft loss vendor. Other example embodiments may omit this condition, as indicated by the dotted lines used in FIG. 6.

The conditions may, according to an example embodiment, further comprise a requirement that the insured party elects to have the loss draft vendor release the loss draft funds to the borrower without the loss draft vendor monitoring the collateral for application of the funds to the repair of the collateral. See condition 530. According to an example embodiment, condition 530 may further require that the insured party elects to have the loss draft vendor release the loss draft funds in their entirety, i.e., the insured party may not elect a partial release of the funds to the borrower.

The conditions may, according to an example embodiment, further comprise a requirement that the borrower fails to apply the released funds to the repair of the collateral property. See condition 540.

The conditions may, according to an example embodiment, further comprise a requirement that the borrower becomes delinquent on the loan. See condition 550. Condition 550 may, according to an example embodiment, comprise a time-based requirement, e.g., that the borrower becomes delinquent by a certain, e.g., fixed, period of time, such as 90 days. According to another example embodiment, the conditions may additionally or alternatively comprise a requirement that the insured party is required to repurchase the loan. See condition 560. Condition 560 may, according to an example embodiment, further require that the insured party is required to repurchase the secured loan due to the release of the funds. It will be understood that conditions 550 and 560 may be provided as alternatives, such that the satisfaction of only one of either condition 550 or condition 560 is required. According to another example embodiment, both conditions 550 and 560 may be required to be satisfied. According to another example embodiment, either or both of conditions 550 and 560 may be required to be satisfied within a certain, e.g., fixed, period of time from a particular event. For example, either or both of conditions 550 and 560 may be required to be satisfied within a certain period of time from the release of the loss draft funds to the borrower, such as within 2 years of the release.

As is further shown in FIG. 6, the insurance policy may provide for a reimbursement payment to be made to the insured party in an instance in which the conditions are satisfied. See operation 570. According to an example embodiment, the reimbursement payment may comprise a first amount of the released funds minus a value of any completed repair work performed on the collateral property. According to another example embodiment, the reimbursement payment may additionally or alternatively include a second amount equal to administrative expenses resulting from the insured party's repurchase of the secured loan. This second amount may, according to an example embodiment, be capped. For example, the second amount maybe capped as a fixed percentage of the first amount, e.g. 25% of the first amount. According to another example embodiment, the second amount may expressly exclude the actual repurchase amount.

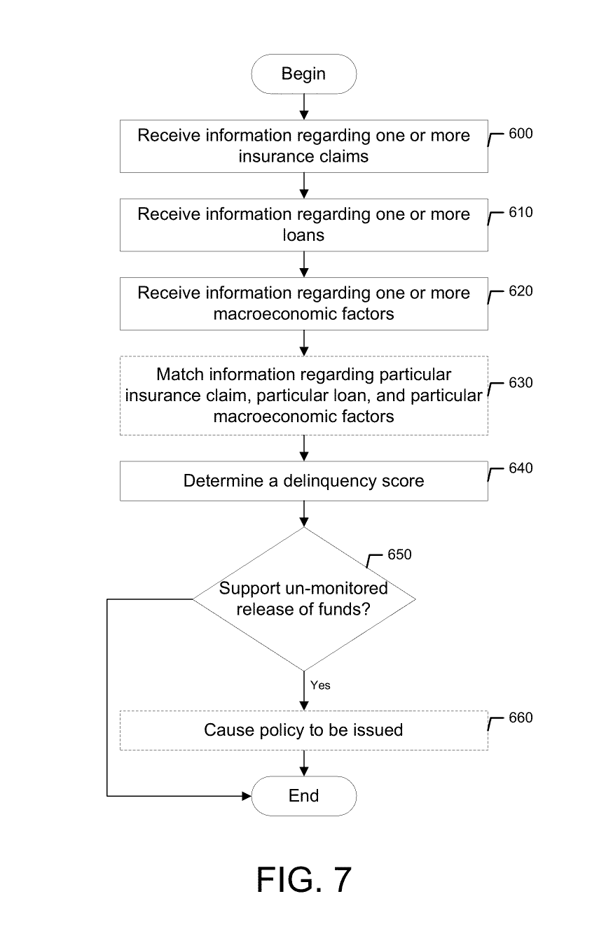

Having thus described loss draft insurance products which may be provided according to example embodiments, attention will now be directed to FIG. 7 in order to describe various operations which may be performed by the Risk Analysis Component 60.

### Risk Analysis

Various embodiments may provide the ability to analyze one or more risk components, such as in order to determine whether to issue an insurance policy, such as a loss draft policy in accordance with an example embodiment as discussed above. For example, risk analysis may be conducted in order to determine a risk of delinquency, e.g., a risk that a borrower will become delinquent on a loan owned or serviced by a lender. Accordingly, the risk analysis may result in a determination of whether a loss draft insurance policy may be issued with the lender as the insured party.

As depicted in FIG. 7, the Risk Analysis Component may comprise means, such as the one or more processors 212, the one or more memory devices 214, the communication interface 218, and/or the like, for receiving information regarding one or more insurance claims. See operation 600. The information may, for example, be received from one or more databases, such as the database(s) 30 depicted in FIG. 2. The information may, for example, comprise information regarding insurance claims resulting from losses to property being used as collateral in a secured loan, such as losses to real property securing a mortgage.

The Risk Analysis Component may further comprise means, such as those listed above, for receiving information regarding one or more loans. See operation 610. The information may, for example, comprise, for each loan, one or more of the following: a client number (e.g., a client portfolio number), a geographical location (e.g., a region, state, city, or the like), a loan number, an original loan amount (e.g., an original mortgage amount), an original collateral property value (e.g., an original value of the real property subject to the mortgage), an investor name, a principal balance, a coverage amount, a current collateral property value, an interest rate of the loan, and/or a loan origination date.

Following receipt of the information regarding one or more loans, one or more input scrubbing operations may be performed. For example, one or more fields, such as the investor name, may be non-standardized and, accordingly, may be corrected for typos and standardized, such as by replacing the names with codes. This may be accomplished by any input scrubbing means known in the art, such as through the use of regular expressions, or the like. One or more data transformation operations may additionally or alternatively be performed following receipt of the information regarding the one or more loans. For example, one or more of the following information may be calculated using the received information:

$$original loan \text{-} to \text{-} value ratio = \frac{original mortgage amount}{original property value} ;$$

$$unpaid balance \text{-} to \text{-} coverage amount ratio = \frac{principal balance}{coverage amount} ;$$

$$current property \text{-} to \text{-} original property value ratio = \frac{current property value}{original property value} ;$$

loan interest rate risk spread=loan interest rate−US Treasury Bond interest rate (e.g., a 10 Year US Treasury rate); and/or

loan investor code, e.g., if an investor name is one of an approved set of investor names, such as Fannie Mae, Freddie Mac, GNMA, The Federal Home Loan Bank, etc., the loan investor code may be set to 1, while if the investor name is not one of the approved set of investor names, the investor code may be set to 0.

The Risk Analysis Component may further comprise means, such as those listed above, for receiving information regarding one or more macroeconomic factors. See operation 620. The one or more macroeconomic factors may, according to an example embodiment, comprise loan delinquency information. The loan delinquency information may, for example, be organized by geographical area, e.g., state, and may, according to one example embodiment, may be drawn from a source such as the National Delinquency Survey by the Mortgage Bankers Association. The loan delinquency information may, for example, comprise information regarding loans that are “seriously delinquent,” e.g., the percentage of loans that are 90+ days delinquent or in foreclosure for a given geographical area (the “rate of serious delinquency”). According to another example embodiment, the macroeconomic factors may additionally or alternatively comprise an unemployment rate. The unemployment rate may, for example, comprise an unemployment rate for a period of time prior to the loan and insurance claim data, such as one year prior. According to yet another example embodiment, the macroeconomic factors may additionally or alternatively comprise a US Treasury Bond Rate, such as a 10 Year Treasury Rate. The US Treasury Bond Rate may, for example, correspond to a loan origination date

The Risk Analysis Component may further comprise means, such as those listed above, for matching information regarding a particular insurance claim of the one or more insurance claims, information regarding a particular loan of the one or more loans, and particular information regarding the one or more macroeconomic factors. See operation 630. With respect to the information regarding the particular insurance claim and particular loan, this data may, for example, be matched based on the borrower, or any other identifying information contained in the aforementioned information. The information regarding the one or more macroeconomic factors may, for example, be matched with the information regarding the particular claim and particular loan may be matched, for example, based on geographic location. For example, unemployment data and loan delinquency data may be organized by state name and, accordingly, may be matched with particular loans/insurance claims based on the states associated with those particular loans/insurance claims. According to another example embodiment, the Risk Analysis Component may filter out any insurance claims associated with known delinquent loans.

The Risk Analysis Component may further comprise means, such as those listed above, for determining a delinquency score. See operation 640. The delinquency score may be determined, for example, based at least in part on the information regarding the particular loan, the information regarding the particular insurance claim, and the particular information regarding the one or more macroeconomic factors. The delinquency score may, according to an example embodiment, be determined based at least in part on a model which receives this information as parameters. The model may, for example, comprise an equation, such as an equation determined via one or more statistical techniques such as, for example, logistic regression. According to one example embodiment, the delinquency score may be calculated using an equation which utilizes the following parameters: the original loan-to-value ratio, the unpaid balance-to-coverage amount ratio, the current property-to-original property value ratio, the loan interest rate risk spread, the loan investor code, the unemployment rate, and the rate of serious delinquency. The equation may, for example, assign weights to each of these parameters. As a specific example, the delinquency score may be determined as follows:

$$Delinquency score = \frac{1}{1 + {e}^{- equation}} , \\ where equation = - 3.085055541 + ( Original Loan \text{-} to \text{-} Value Ratio ) ( 3.23534139 ) + ( Unpaid Balance \text{-} to \text{-} Coverage Amount Ratio ) ( 0.40742326 ) + ( Current Property \text{-} to \text{-} Original Property Value Ratio ) ( - 3.53642844 ) + ( Loan Interest Rate Risk Spread ) ( 0.08547277 ) + ( Investor ID ) ( - 0.95667056 ) + ( Unemployment Rate ) ( 0.00291956 ) + ( Rate of Serious Delinquency ) ( 0.05738016 )$$

The Risk Analysis Component may further comprise means, such as those listed above, for determining, based at least in part on the delinquency score, whether to support an un-monitored release of loss draft funds. See operation 650. The determination of whether to issue the policy may, for example, comprise comparing the delinquency score to a threshold, such that if the delinquency score satisfies the threshold, it is determined that a policy should be issued while if the delinquency score does not satisfy the threshold, it is determined that a policy should not be issued.

The Risk Analysis Component may further comprise means, such as those listed above, for, in an instance in which it is determined to support the un-monitored release of loss draft funds, causing the un-monitored release of loss draft funds to be supported. See operation 660. According to an example embodiment, supporting the un-monitored release of loss draft funds may, for example, comprise insuring the loss draft, such as by issuing or administering an insurance policy, such as a loss draft insurance policy as described above. According to another example embodiment, supporting the un-monitored release of loss draft funds may comprise releasing the funds directly, such as in an instance in which operation 650 is carried out by a Risk Analysis Component under control of a loss draft vendor. Causing the un-monitored release of loss draft funds to be supported may, according to an example embodiment, comprise causing an approval indication to be transmitted, such as via the network 15, to the Plan Implementation Component 50, the approval indication indicating that a policy may be issued. According to another example embodiment, causing the un-monitored release of loss draft funds to be supported may comprise causing a fund release indication to be transmitted, such as via the network 15, to a loss draft vendor, the fund release indication comprising instructions to release funds.

### CONCLUSION

FIGS. 5 and 6 each illustrate a flowchart of a system, method, and computer program product according to some example embodiments. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may comprise one or more memory devices of a computing device (for example, the memory 65, 66, 67, and/or 214) storing instructions executable by a processor in the computing device (for example, by the processor(s) 60, 310, and/or 212). In some example embodiments, the computer program instructions of the computer program product(s) which embody the procedures described above may be stored by memory devices of a plurality of computing devices. As will be appreciated, any such computer program product may be loaded onto a computer or other programmable apparatus (for example, a Plan Implementation Component 50, a Risk Analysis Component 60, and/or other apparatus) to produce a machine, such that the computer program product including the instructions which execute on the computer or other programmable apparatus creates means for implementing the functions specified in the flowchart block(s).

Further, the computer program product may comprise one or more computer-readable memories on which the computer program instructions may be stored such that the one or more computer-readable memories can direct a computer or other programmable apparatus to function in a particular manner, such that the computer program product may comprise an article of manufacture which implements the function specified in the flowchart block(s). The computer program instructions of one or more computer program products may also be loaded onto a computer or other programmable apparatus (for example, a Plan Implementation Component 50, a Risk Analysis Component 60, and/or other apparatus) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed:

1. A method comprising:
receiving information regarding a loan secured by collateral;
receiving information regarding an insurance claim for a loss to the collateral;
receiving information regarding one or more macroeconomic factors related to the loan secured by collateral;
determining, via a processor, a delinquency score based at least in part on the received information;
determining, based at least in part on the delinquency score, whether to support an un-monitored release of loss draft funds, said determining comprising comparing the delinquency score to a predetermined threshold; and, in an instance in which it is determined to support the un-monitored release of loss draft funds:
receiving an indication that at least a portion of the released loss draft funds have not been applied to repairing the loss to the collateral, and
providing an authorization to release a reimbursement payment in an instance in which, within a delinquency period, the secured loan has been repurchased or the secured loan enters delinquency.

2. The method of claim 1, wherein receiving information regarding an insurance claim for a loss to the collateral comprises receiving information regarding a plurality of insurance claims, the method further comprising filtering from the information regarding the plurality of insurance claims, information regarding insurance claims known to be associated with delinquent loans.

3. The method of claim 1, wherein the information regarding the loan secured by collateral comprises one or more of: a state, an original mortgage amount, an original property value, a principal balance, a coverage amount, a current property value, an interest rate, and an origination date.

4. The method of claim 3, wherein the information regarding the loan secured by collateral further comprises an investor name.

5. The method of claim 1, wherein the information regarding one or more macroeconomic factors comprises loan delinquency information.

6. The method of claim 1, wherein the information regarding one or more macroeconomic factors comprises information regarding an unemployment rate.

7. The method of claim 1, wherein the information regarding one or more macroeconomic factors comprises one or more interest rates of one or more US Treasury Bonds.

8. The method of claim 7, wherein the interest rates of the one or more US Treasury Bonds comprise the interest rate of a 10 year US Treasury Bond.

9. The method of claim 7, wherein the interest rate of the one or more US Treasury Bonds comprise the interest rate of one or more US Treasury Bonds calculated on or after an origination date of the loan secured by collateral.

10. The method of claim 1, wherein the loss draft funds are released by a loss draft vendor selected from a plurality of approved loss draft vendors.

11. The method of claim 1, wherein the delinquency period is two years.

12. The method of claim 1, wherein the reimbursement payment comprises a first amount equal to the released funds minus a value of repairs performed on the collateral.

13. The method of claim 12, wherein the reimbursement payment further comprises a second amount equal to any administrative expenses directly resulting from the insured party's required repurchase of the secured loan, the administrative expenses not including the actual repurchase amount.

14. The method of claim 13, wherein the second amount is capped at a percentage of the first amount.

15. The method of claim 14, wherein the percentage of the first amount is 25%.

16. The method of claim 1, wherein the reimbursement payment is capped based at least in part on the delinquency score.

17. The method of claim 1, further comprising determining a premium payment based at least in part on the delinquency score.

18. An apparatus comprising at least one processor and at least one memory having program instructions stored therein, the memory and program instructions being configured to, with the at least one processor, cause the apparatus to at least:
receive information regarding a loan secured by collateral;
receive information regarding one or more macroeconomic factors related to the loan secured by collateral;
determine a delinquency score based at least in part on the received information determine, based at least in part on the delinquency score, whether to
support an un-monitored release of loss draft funds, said determining comprising comparing the delinquency score to a threshold; and, in an instance in which it is determined to support the un-monitored release of loss draft funds:
receive an indication that at least a portion of the released loss draft funds have not been applied to repairing the loss to the collateral, and
provide an authorization to release a reimbursement payment in an instance in which, within a delinquency period, the secured loan has been repurchased or the secured loan enters delinquency.

19. The apparatus of claim 18, wherein the apparatus is caused to receive a plurality of insurance claims, the apparatus being further caused to filter from the information regarding the plurality of insurance claims, information regarding insurance claims known to be associated with delinquent loans.

20. The apparatus of claim 18, wherein the information regarding the loan secured by collateral comprises one or more of: a state, an original mortgage amount, an original property value, a principal balance, a coverage amount, a current property value, an interest rate, and an origination date.

21. The apparatus of claim 20, wherein the information regarding the loan secured by collateral further comprises an investor name.

22. The apparatus of claim 18, wherein the information regarding one or more macroeconomic factors comprises loan delinquency information.

23. The apparatus of claim 18, wherein the information regarding one or more macroeconomic factors comprises information regarding an unemployment rate.

24. The apparatus of claim 18, wherein the information regarding one or more macroeconomic factors comprises one or more interest rates of one or more US Treasury Bonds.

25. The apparatus of claim 24, wherein the interest rates of the one or more US Treasury Bonds comprise the interest rate of a 10 year US Treasury Bond.

26. The apparatus of claim 24, wherein the interest rate of the one or more US Treasury Bonds comprise the interest rate of one or more US Treasury Bonds calculated on or after an origination date of the loan secured by collateral.

27. The apparatus of claim 18, wherein the loss draft funds are released by a loss draft vendor selected from a plurality of approved loss draft vendors.

28. The apparatus of claim 18, wherein the delinquency period is two years.

29. The apparatus of claim 18, wherein the reimbursement payment comprises a first amount equal to the released funds minus a value of repairs performed on the collateral.

30. The apparatus of claim 29, wherein the reimbursement payment further comprises a second amount equal to any administrative expenses directly resulting from the insured party's required repurchase of the secured loan, the administrative expenses not including the actual repurchase amount.

31. The apparatus of claim 30, wherein the second amount is capped at a percentage of the first amount.

32. The apparatus of claim 31, wherein the percentage of the first amount is 25%

33. The apparatus of claim 18, wherein the reimbursement payment is capped based at least in part on the delinquency score.

34. The apparatus of claim 18, wherein the apparatus is further caused to determine a premium payment based at least in part on the delinquency score.

35. A computer program product comprising a non-transitory computer-readable storage medium having program code portions embodied therein, the program code portions being configured to, upon execution, cause an apparatus to at least:
receive information regarding loan secured by collateral;
receive information regarding one or more macroeconomic factors related to the loan secured by collateral;
determine a delinquency score based at least in part on the received information
determine, based at least in part on the delinquency score, whether to support an un-monitored release of loss draft funds, by at least comparing the delinquency score to a threshold; and, in an instance in which it is determined to support the un-monitored release of loss draft funds:
receive an indication that at least a portion of the released loss draft funds have not been applied to repairing the loss to the collateral, and
provide an authorization to release a reimbursement payment in an instance in which, within a delinquency period, the secured loan has been repurchased or the secured loan enters delinquency.

36. The apparatus of claim 18, wherein the apparatus is caused to receive a plurality of insurance claims, the apparatus being further caused to filter from the information regarding the plurality of insurance claims, information regarding insurance claims known to be associated with delinquent loans.

37. The computer program product of claim 35, wherein the information regarding the loan secured by collateral comprises one or more of: a state, an original mortgage amount, an original property value, a principal balance, a coverage amount, a current property value, an interest rate, and an origination date.

38. The computer program product of claim 37, wherein the information regarding the loan secured by collateral further comprises an investor name.

39. The computer program product of claim 35, wherein the information regarding one or more macroeconomic factors comprises loan delinquency information.

40. The computer program product of claim 35, wherein the information regarding one or more macroeconomic factors comprises information regarding an unemployment rate.

41. The computer program product of claim 35, wherein the information regarding one or more macroeconomic factors comprises one or more interest rates of one or more US Treasury Bonds.

42. The computer program product of claim 41, wherein the interest rates of the one or more US Treasury Bonds comprise the interest rate of a 10 year US Treasury Bond.

43. The computer program product of claim 41, wherein the interest rate of the one or more US Treasury Bonds comprise the interest rate of one or more US Treasury Bonds calculated on or after an origination date of the loan secured by collateral.

44. The computer program product of claim 35, wherein the loss draft funds are released by a loss draft vendor selected from a plurality of approved loss draft vendors.

45. The computer program product of claim 35, wherein the delinquency period is two years.

46. The computer program product of claim 35, wherein the reimbursement payment comprises a first amount equal to the released funds minus a value of repairs performed on the collateral.

47. The computer program product of claim 35, wherein the reimbursement payment further comprises a second amount equal to any administrative expenses directly resulting from the insured party's required repurchase of the secured loan, the administrative expenses not including the actual repurchase amount.

48. The computer program product of claim 35, wherein the second amount is capped at a percentage of the first amount.

49. The computer program product of claim 35, wherein the percentage of the first amount is 25%.

50. The apparatus of claim 18, wherein the reimbursement payment is capped based at least in part on the delinquency score.

51. The apparatus of claim 18, wherein the apparatus is further caused to determine a premium payment based at least in part on the delinquency score.
